(19) United States
(12) Patent Application Publication
(10) Pub. No.: US 2025/0332059 A1
(43) Pub. Date: Oct. 30, 2025

(54) MULTI-FUNCTIONAL BOTTLE HEAD

(71) Applicant: SHENZHEN NUON MEDICAL EQUIPMENT CO., LTD., Shenzhen (CN)

(72) Inventors: ALAIN DIJKSTRA, Amstelveen (NL); LI XIANG, Shenzhen (CN)

(73) Assignee: SHENZHEN NUON MEDICAL EQUIPMENT CO., LTD., Shenzhen (CN)

(21) Appl. No.: 18/925,117

(22) Filed: Oct. 24, 2024

(30) Foreign Application Priority Data
Apr. 30, 2024 (CN) 2024105477769
Apr. 30, 2024 (CN) 2024209419626
Apr. 30, 2024 (CN) 2024209454757

(51) Int. Cl. A61H 15/00; A61H 15/02

(52) U.S. Cl. CPC A61H 15/0092; A61H 15/02; A61H 2015/0064; A61H 2015/0071; A61H 2201/105

(57) ABSTRACT

Embodiments of the present invention provide a multi-functional bottle head having a massage head for providing massage therapy. The massage head comprises a housing having a first end for connecting to a bottle and a second end arranged relative to the first end. The second end of the housing comprises a circulating groove arranged in annular manner on the face of the second end. A plurality of rolling pieces are positioned in the circulating groove for providing rolling massage to the skin. The plurality of rolling pieces are arranged sequentially along the circulating groove.

### TECHNICAL FIELD

The present invention relates generally to a multi-functional bottle head. More specifically, the present invention relates to a bottle head having a massage head and one or more stimulation elements for providing therapy to a user.

### BACKGROUND ART

The conventional massage head comprises a shell and a plurality of limit grooves, each limit groove has a ball positioned in the groove. When the massage head is used for massaging the skin, the balls are held against the surface of the skin, and as the user pushes the massage head, each ball rotates in the corresponding limit groove and slide along the skin to achieve rolling massage on the skin. Due to the limited area of the end of the massage head and less number of balls, when the massage head is used for massage, the contact surface between the ball and the skin is small, and the balls are inconsistent with the limit groove, causing the balls to rotate inconsistently and limiting the massage effect.

Some of the conventional massage head has a light source to provide phototherapy. The massage head comprises a shell, a plurality of balls and a phototherapy light source installed at a liquid outlet hole that is in connection with a bottle body. The shell comprises a plurality of grooves for accommodating the balls. The liquid outlet end of the shell is provided with a light transmission plate corresponding to the position of the light source. The balls are arranged on two sides of the light transmission plate. The area of the liquid end of the shell is smaller and the area occupied by the balls is larger and the area occupied by the light transmission plate is smaller, thereby resulting in smaller phototherapy area. This affects the overall impact of the phototherapy effect.

### OBJECTS OF THE INVENTION

Some of the objects of the invention are as follows:

An object of the present invention is to provide a multi-functional bottle head with a massage head that provides a large contact surface between the ball and the skin.

Another object of the present invention is to provide a multi-functional bottle head having a massage head in which the ball rotates consistently when the massage head is used for massaging the skin.

Another object of the present invention is to provide a multi-functional bottle head that provides a large phototherapy area for providing therapy to a user.

Another object of the present invention is to provide a multi-functional bottle head with a light transmission plate with a large surface area.

### SUMMARY OF THE INVENTION

According to a first aspect of the present invention, a multi-functional bottle head is provided. The multi-functional bottle head comprising: a housing having a first end for connecting a bottle body and a second end having a circulating groove arranged in an annular manner; a plurality of rolling pieces placed in the circulating groove, wherein height of each of the plurality of rolling piece is more than depth of the circulating groove; a liquid outlet hole that runs through the first end and the second end in housing for communicating with the bottle body; wherein the circulating groove is arranged around the liquid outlet hole.

In one embodiment of the invention, the housing comprises a shell having an accommodating groove and a limiting part positioned at center of the accommodating groove; wherein the shell and the limiting part form the circulating groove.

In one embodiment of the invention the shell comprises a first perforation, and the limiting part comprises a second perforation communicated with the first perforation, wherein the first perforation and the second perforation forms the liquid outlet hole.

In one embodiment of the invention, the limiting part comprises a limiting ring to place the limiting part in the accommodating groove, wherein diameter of the limiting ring increases from bottom of the accommodating groove to an opening of the accommodating groove.

In one embodiment of the invention, the plurality of rolling pieces are a ball, wherein width of an opening of the circulating groove is less than diameter of the ball.

In one embodiment of the invention, ratio of the depth of the circulating groove to the height of the rolling piece ranges from 0.55-0.95.

In one embodiment of the invention, the number of the circulating grooves in the housing is in range of 1 to 6.

In one embodiment of the invention, the number of plurality of rolling piece is in range of 5 to 50.

In one embodiment of the invention, the second end of the housing is inclined at an angle, the angle is in range of 15 degree to 75 degree.

In one embodiment of the invention, the housing further comprises a plate having one or more stimulation element to provide therapy to a user.

In one embodiment of the invention, the output part comprises a phototherapy lamp plate for skin phototherapy, a vibrator for vibrating massage and at least one micro-current electrode for providing micro-current to the skin.

According to a second aspect of the present invention, a multi-functional bottle head is provided. The multi-functional bottle head comprising: a housing having a liquid outlet hole, the liquid outlet hole has an outlet area arranged around the liquid outlet hole; a plate containing one or more stimulation element is provided below the outlet area; a plurality of rolling piece is installed in the outlet area, above the plate containing one or more stimulation element.

In one embodiment of the invention, the one or more stimulation element is a phototherapy light source comprising a lamp board arranged around the liquid outlet hole, a circuit board electrically connected with the lamp board and a battery electrically connected with the circuit board.

In one embodiment of the invention, the housing comprises a shell, a support disc installed at the liquid outlet end and a limiting piece for limiting the support disc to be located on the shell.

In one embodiment of the invention, the support disc comprises an accommodating groove and a first opening is provided in the accommodating groove; and the lamp board comprises a second opening, wherein the limiting part passes through the first opening and the second opening.

In one embodiment of the invention, the shell comprises a first perforation and the limiting part comprises a second perforation, the first perforation and the second perforation are connected to from the liquid outlet hole.

In one embodiment of the invention, the supporting disc is transparent to allow the light to pass through.

In one embodiment of the invention, the plurality of rolling piece are transparent.

In one embodiment of the invention, the multi-functional bottle head further comprising a seal, the seal comprises an annular translucent disc and a sealing ring connected with an inner edge of the translucent disc.

In one embodiment of the invention, the housing comprises a circulating groove arranged around the liquid outlet hole and the plurality of rolling piece are arranged in annular array in the circulating groove.

According to a third aspect of the present invention, a multi-functional bottle head is provided. The multi-functional bottle head comprising: a housing having a first end for connecting a bottle body and a second end having a circulating groove arranged in an annular manner; a plurality of rolling pieces placed in the circulating groove; a liquid outlet hole that runs through the first end and the second end in housing for communicating with the bottle body; wherein the second end of the housing comprises a second stimulation element.

In one embodiment of the present invention, the second stimulation element is a metal plate around the liquid outlet hole.

In one embodiment of the present invention, the circumference of the circulating groove is a metal part that acts as the second stimulation element.

In the context of the specification, the term “processor” refers to one or more of a microprocessor, a microcontroller, a general-purpose processor, a Field Programmable Gate Array (FPGA) or an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a non-volatile storage memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of this specification, terms like “light”, “radiation”, “irradiation”, “emission” and “illumination”, etc. refer to electromagnetic radiation in frequency ranges varying from the Ultraviolet (UV) frequencies to Infrared (IR) frequencies and wavelengths, wherein the range is inclusive of visible light, UV and IR frequencies and wavelengths. It is to be noted here that UV radiation can be categorized in several manners depending on respective wavelength ranges, all of which are envisaged to be under the scope of this invention. For example, UV radiation can be categorized as, Hydrogen Lyman-α (122-121 nm), Far UV (200-122 nm), Middle UV (300-200 nm), and Near UV (400-300 nm). The UV radiation may also be categorized as UVA (400-315 nm), UVB (315-280 nm), and UVC (280-100 nm) Similarly, IR radiation may also be categorized into several categories according to respective wavelength ranges which are again envisaged to be within the scope of this invention. A commonly used subdivision scheme for IR radiation includes Near IR (0.75-1.4 μm), Short-Wavelength IR (1.4-3 μm), Mid-Wavelength IR (3-8 μm), Long-Wavelength IR (8-15 μm) and Far IR (15-1000 μm).

In the context of the specification, when an element is referred to as being “fixed to” or “disposed to” another element, it may either directly on another element or indirectly on that other element. When a component is said to be “connected” or “connected to” another component, it may be directly connected to another component or indirectly connected to other component on the piece.

In the context of the specification, the terms “first’, “second” and “third” are only used for descriptive purpose and does not implicate the relative importance or to implicitly indicate the quantity of technical features indicated.

In the context of the specification, the term “plurality” means two or more than two, unless otherwise indicated.

In the context of the specification, the term “several” means more than one, unless otherwise specified.

In the context of the specification, “Light Emitting Diodes (LEDs)” refer to semiconductor diodes capable of emitting electromagnetic radiation when supplied with an electric current. The LEDs are characterized by their superior power efficiencies, smaller sizes, rapidity in switching, physical robustness, and longevity when compared with incandescent or fluorescent lamps. In that regard, the one or more LEDs may be through-hole type LEDs (generally used to produce electromagnetic radiations of red, green, yellow, blue and white colors), Surface Mount Technology (SMT) LEDs, Bi-color LEDs, Pulse Width Modulated RGB (Red-Green-Blue) LEDs, and high-power LEDs, etc.

Materials used in the one or more LEDs may vary from one embodiment to another depending upon the frequency of radiation required. Different frequencies can be obtained from LEDs made from pure or doped semiconductor materials. Commonly used semiconductor materials include nitrides of Silicon, Gallium, Aluminum, and Boron, and Zinc Selenide, etc. in pure form or doped with elements such as Aluminum and Indium, etc. For example, red and amber colors are produced from Aluminum Indium Gallium Phosphide (AlGaInP) based compositions, while blue, green, and cyan use Indium Gallium Nitride based compositions. White light may be produced by mixing red, green, and blue lights in equal proportions, while varying proportions may be used for generating a wider color gamut. White and other colored lightings may also be produced using phosphor coatings such as Yttrium Aluminum Garnet (YAG) in combination with a blue LED to generate white light and Magnesium doped potassium fluorosilicate in combination with blue LED to generate red light. Additionally, near Ultraviolet (UV) LEDs may be combined with europium-based phosphors to generate red and blue lights and copper and zinc doped zinc sulfide-based phosphor to generate green light.

In addition to conventional mineral-based LEDs, one or more LEDs may also be provided on an Organic LED (OLED) based flexible panel or an inorganic LED-based flexible panel. Such OLED panels may be generated by depositing organic semiconducting materials over Thin Film Transistor (TFT) based substrates. Further, discussion on generation of OLED panels can be found in Bardsley, J. N (2004), “International OLED Technology Roadmap”, IEEE Journal of Selected Topics in Quantum Electronics, Vol. 10, No. 1, that is included herein in its entirety, by reference. An exemplary description of flexible inorganic light-emitting diode strips can be found in granted U.S. Pat. No. 7,476,557 B2, titled “Roll-to-roll fabricated light sheet and encapsulated semiconductor circuit devices”, which is included herein in its entirety, by reference.

In several embodiments, the one or more LEDs may also be micro-LEDs described through U.S. Pat. Nos. 8,809,126 B2, 8,846,457 B2, 8,852,467 B2, 8,415,879 B2, 8,877,101 B2, 9,018,833 B2 and their respective family members, assigned to Nth Degree Technologies Worldwide Inc., which are included herein by reference, in their entirety. The one or more LEDs, in that regard, may be provided as a printable composition of the micro-LEDs, printed on a substrate.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 illustrates an assembly of a multi-functional bottle head with a bottle body in accordance with an embodiment of the present invention.

FIG. 2 illustrates a three-dimensional structure of the multi-functional bottle head in accordance with an embodiment of the present invention.

FIG. 3 represents a cross-sectional structure of the multi-functional bottle head in accordance with an embodiment of the present invention.

FIG. 4 illustrates a magnified view of area A of FIG. 3 in accordance with an embodiment of the present invention.

FIG. 5 illustrates an exploded view of a multi-functional bottle head in accordance with an embodiment of the present invention.

FIG. 6 illustrates a top perspective view of a plugging section of the multi-functional bottle head in accordance with an embodiment of the present invention.

FIG. 7 illustrates a support disc of the multi-functional bottle head in accordance with an embodiment of the present invention.

FIG. 8 illustrates a limiting part of the multi-functional bottle head in accordance with an embodiment of the present invention.

FIG. 9 illustrates a seal of the multi-functional bottle head in accordance with an embodiment of the present invention.

FIG. 10 illustrates a plate having one or more stimulation element in the multi-functional bottle head in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention disclose a multi-functional bottle head for massaging the skin. The multi-functional bottle head comprises a housing having a first end for connecting to a bottle body and a second end opposite to the first end. The second end of the housing has a circulating groove arranged annular on the end face of the second end. A plurality of rolling pieces are placed sequentially along the circulating groove. The height of each of the rolling piece is greater than the depth of the circulating groove. The circulating grove is a continuous circular groove and the plurality of rolling pieces are arranged sequentially that reduces the distance between adjacent rolling piece, thereby increasing the number of rolling piece per unit area. When using the multi-functional bottle head for massaging, with the movement of the housing, the rolling piece rotates on its axis and rolled along the circulating groove in circle. This improves the rolling consistency of the rolling piece and improves the massage effect.

Another embodiment of the present invention discloses a multi-functional bottle head for providing massage and an alternate therapy to a user. The multi-functional bottle head comprises a housing having a liquid outlet hole that penetrates through two ends of the housing. The liquid outlet end of the housing is provided with a light outlet area arranged around the liquid outlet hole. A plate having one or more stimulation element, such a phototherapy light source is installed in the outlet area. A plurality of rolling pieces are arranged around the outlet area located on the output end of the plate having one or more stimulation elements. The location of the plurality of rolling pieces on the outlet area increases the area of the light outler and ratio of the area of the light outlet to the area of liquid inlet is increase, thereby increasing the affect of phototherapy.

Several additional functionalities may also be added to the multi-functional bottle head. For example, the multi-functional bottle head may have one or more sensors to sense the pH and monitor one or more parameters of the skin of a user. Moreover, activation and control of specific stimulation elements may be based upon feedback received from the one or more sensors, such as pressure sensors (for ascertaining contact with a body portion of the user) and temperature sensors (for maintaining the temperature of heating and/or cooling elements within permissible limits) about several parameters, such as skin temperature, treatment time, skin pH. Electrical power to operate the components may be provided through an onboard rechargeable battery that may be charged using a power cable.

Several embodiments of the present invention will now be described in detail with references to FIGS.

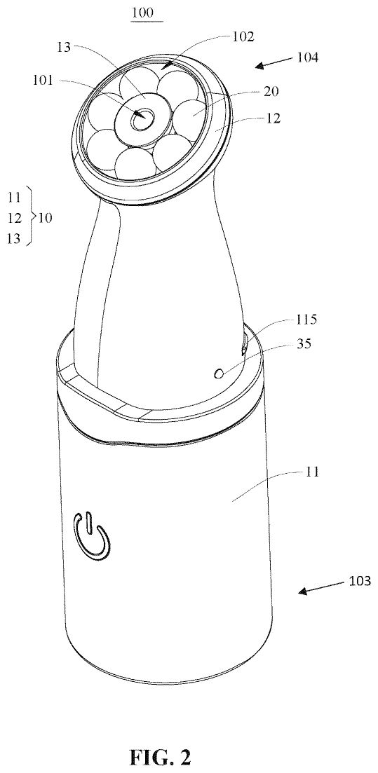

Referring to FIG. 2 to FIG. 4 the multi-functional bottle head serves as function of a massage head. The massage head 100 comprises a housing 10 and a plurality of rolling pieces 20. The housing 10 has a first end 103 and a second end 104, the first end 103 is used for connecting the bottle body 300, and the second end 104 is arranged relative to the first end 103. The second end 104 of the housing 10 is provided with a circulating groove 102, arranged in annular manner on the end face of the second end 104. A plurality of rolling pieces 20 are used for rolling massage. The plurality of rolling pieces 20 are placed in the circulating groove 102, and are arranged sequentially along the circulating grooves 102. The height of each rolling piece 20 is greater than the depth of the circulating groove 102, that is, the rolling pieces 20 are at least partially exposed in the circulating grooves 102. The circulating groove 102 is in annular shape and a plurality of rolling pieces 20 are installed in the circulating groove 102 that reduces the distance between adjacent rolling pieces 20, and the number of rolling pieces 20 per unit area is large. When the massage head 100 is massaged, with the movement of the housing 10, the rolling piece 20 can not only rotate, but also can roll along the circulating groove 102 cycle, so that the consistency of the rolling piece 20 rolling is conducive to improving and the massage effect is promoted.

Referring to FIG. 2 to FIG. 4, the housing 10 is provided with an liquid outlet hole 101 for communicating with the bottle body 300. The liquid outlet hole 101 runs through the first end 103 and the second end 104, and the circulating groove 102 is arranged around the outlet of the liquid outlet hole 101. When the second end 104 of the housing 10 is connected with the bottle body 300, the liquid outlet hole 101 in connected with the bottle body 300, so that the liquid medicine in the bottle body 300 can be easily dispensed. The liquid medicine can be evenly applied to the skin while massaging through the rolling piece 20, so as to improve the massage effect, and the liquid medicine can also play a certain lubricating effect, reduce the resistance of the rolling piece 20 while rolling. The liquid medicine dispensing from the liquid outlet hole 101 may comprise but is not limited to an eye cream, essential oil, etc.

In another embodiment of the present application, the outlet of the liquid outlet hole 101 is in communication with the circulating groove 102. When the liquid medicine is dispensed through the circulating groove 102, the liquid medicine is evenly applied to the skin through the rolling of the rolling piece 20. When the liquid medicine enters the circulating groove 102, the liquid medicine can play a certain lubricating role, and the resistance of the rolling piece 20 while rolling is reduced.

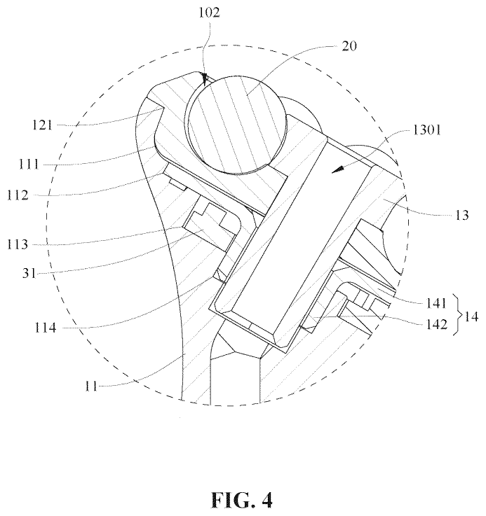

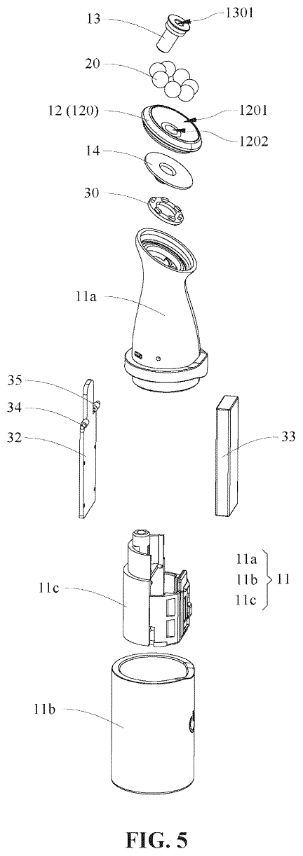

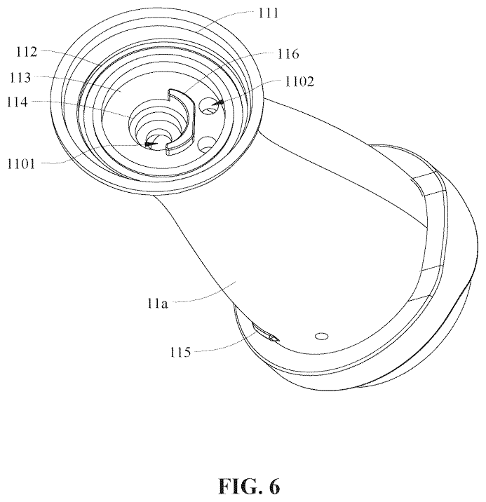

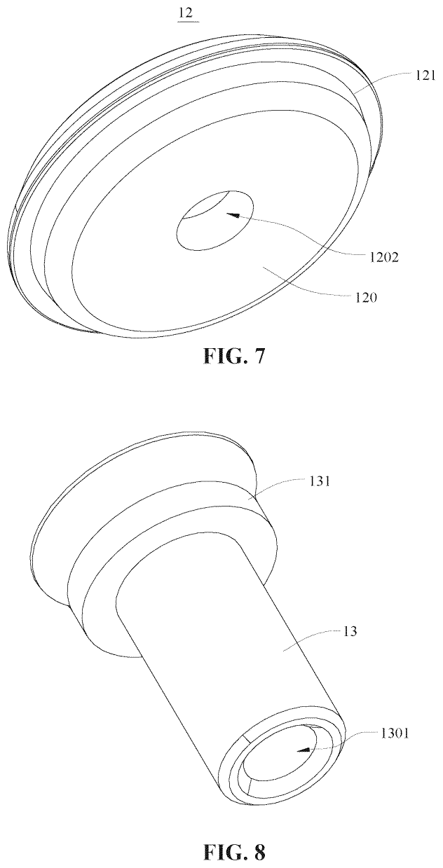

Referring to FIG. 4, FIG. 5 and FIG. 7, the housing 10 comprises a shell 11 and a limiting part 13 installed at one end of the shell 11. An accommodating groove 1201 is formed at one end of the shell 11, and the limiting part 13 is positioned at the middle part of the accommodating groove 1201. The shell 11 and the limiting part 13 form a circulating groove 102 in the accommodating groove 1201. The rolling piece 20 can be conveniently limited in the accommodating groove 1201 by adopting the locating part 13, and the processing of the housing 10 and the assembly of the rolling piece 20 are convenient.

In an embodiment of the present application, referring to FIG. 4, FIG. 5 and FIG. 7, the shell 11 comprises a support disc 12, a plugging section 11a and a connecting section 11b. The plugging section 11a is used for plugging and mating with a cover body 200, and the connecting section 11b is used for connecting with the bottle body 300. The plugging section 11a is connected with the connecting section 11b, and the support disc 12 and the limiting part 13 are connected to the other end of the plugging section 11a. The support disc 12 is provided with a first opening 1202 that is present inside the accommodating groove 1201 and communicates with the bottom of the accommodating groove 1201. The limiting part 13 inserts into the first opening 1202, and connects with the plugging section 11a through other end of the first opening 1202. This facilitates the convenient processing of the shell 11 and disassembly and cleaning of the support disc 12 and the rolling piece 20.

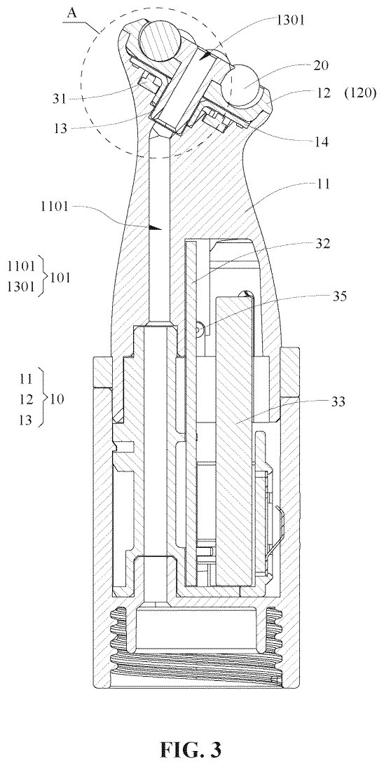

Referring to FIG. 2, FIG. 3 and FIG. 5, the shell 11 may further comprises a bracket 11c installed in the connecting section 11b. A battery 33 and a circuit board 32 are connected with the bracket 11c.

Referring to FIG. 2, FIG. 3 and FIG. 5, a first perforation 1101 is provided in the shell 11, and a second perforation 1301 connected with the first perforation 1101 is provided in the limiting part 13. The second perforation 1301 is arranged along the length direction of the limiting part 13 and penetrates through the two ends of the limiting part 13. The liquid outlet hole 101 comprises the first perforation 1101 and the second perforation 1301. The liquid discharge of liquid medicine can be conveniently controlled by the liquid outlet hole 101 and the processing of liquid outlet hole 101 is convenient. The liquid outlet hole 101 is separated from the circulating groove 102 to prevent the pollution of liquid medicine in liquid outlet hole 101, and the rolling piece 20 can be cleaned conveniently.

In another embodiment of the present application, the liquid outlet hole 101 is formed on the shell 11, and the bottom of the accommodating groove 1201 is connected with the liquid outlet hole 101. The liquid medicine can be conveyed to the bottom of the accommodating groove 1201, so that the liquid medicine can be evenly applied to the skin during the rolling of the rolling piece 20.

Referring to FIG. 4 to FIG. 6, a limiting ring 131 is arranged at one end of the limiting part 13 in the accommodating groove 1201, and the limiting ring 131 is used for cooperating with the side wall of the accommodating groove 1201 to positioned the rolling piece 20 in the accommodating groove 1201. When the limiting part 13 is inserted into the outlet of the first perforation 1101, the support disc 12 is fixed with the plugging section 11a to prevent the support disc 12 from falling off. The outer diameter of the limiting ring 131 is greater than the inner diameter of the first opening 1202, so that the length of the limiting part 13 inserted into the first opening 1202 can be located.

Referring to FIG. 4, FIG. 5 and FIG. 8, the outer diameter of the limiting ring 131 gradually increases from the entrance of the second perforation 1301 to the outlet of the second perforation 1301, so that the rolling piece 20 fits in the accommodating groove 1201. The periphery of the limiting ring 131 can be arc-shaped, so that it is convenient to be matched with the periphery of the rolling piece 20. This helps in reducing the residual liquid medicine in the periphery of the limiting ring 131, and improves the stability of the rotation of the rolling piece 20.

In another embodiment of the present invention, a multi-function bottle head with having a massage head and one or more stimulation element is provided.

Referring to FIG. 2 to FIG. 4, the massage head 100 comprises the housing 10, a plate 30 having one or more stimulation element and the rolling piece 20. The liquid outlet hole 101 is formed in the housing 10 that penetrates through the two ends of the housing 10 along the length direction. The liquid outlet end of the housing 10 is provided with an outlet area 120 arranged around the outlet of the liquid outlet hole 101. The plate 30 having one or more stimulation element is used for carrying out alternate therapy to the skin. The plate 30 having one or more stimulation element is installed in the outlet area 120. The rolling piece 20 is installed in the outlet area 120. The rolling piece 20 is positioned at the outlet side of the plate 30 having one or more stimulation element. The outlet side of the plate 30 having one or more stimulation element is the side that the outlet of the liquid outlet hole 101 is distant from the inlet of the liquid outlet hole 101. By arranging the outlet area 120 at the liquid outlet end of the housing 10, and installing a rolling piece 20 in the outlet area 120, the area of the outlet area 120 can be increased, and the ratio of the area of the outlet area 120 and the area of the liquid outlet end of the housing 10 can be increased.

In an embodiment of the present application, the one or more stimulation element is selected from a group consisting of Light Emitting Diodes (LEDs), lasers, heating elements, cooling elements, vibration elements, electrodes, micro-current element and combinations thereof.

In an embodiment, the one or more stimulation element is a plurality of LEDs for inducing phototherapy to the skin. Referring to FIG. 2, FIG. 3 and FIG. 5, the number of rolling pieces 20 is plurality, the plurality of rolling pieces 20 are arranged around the liquid outlet hole 101. The plate 30 having one or more stimulation element comprises a lamp board 31 arranged around the liquid outlet hole 101, a circuit board 32 electrically connected with the lamp board 31 and a battery 33 electrically connected with the circuit board 32. The lamp board 31, the circuit board 32 and the battery 33 are installed in the housing 10, and the lamp board 31 is located on the light entering side of the outlet area 120. The outlet area 120 is positioned at the outside of the lamp board 31. By adopting the plurality of rolling pieces 20, the contact area between the plurality of rolling piece 20 and the skin of the user is increased. It is also beneficial to evenly apply the liquid medicine to the skin. When the rolling piece 20 is in the process of rolling, the surface is more likely to conduct heat to the outside, the rolling piece helps in heat dissipation of the phototherapy light source, thereby help to improve the power of the lamp board 31, reduce the risk that the temperature of the lamp board 31 is too high or burns the skin.

Referring to FIG. 5 and FIG. 10, the lamp board 31 comprises a substrate 311 and a plurality of LED lamp bead 312 are arranged on the substrate 311, so that the LED lamp board can be used to facilitate the processing of the lamp board 31.

Referring to FIG. 5, FIG. 6 and FIG. 10, the lamp board 31 further comprises a lamp board electrode 313 arranged on the substrate 311. The substrate 311 comprises two lamp board electrodes 313, and the two lamp board electrodes 313 are electrically connected with the circuit board 32. The lamp board electrode 313 may be cylindrical, and a through hole 1102 is formed in the shell 11, and the through hole 1102 is used for the lamp board electrode 313 to be inserted. This ensures that the position of the lamp board 31 can be located, the lamp board 31 is prevented from moving, the circuit connection of the lamp board 31 and the circuit board 32 is convenient, and the sealing isolation of the lamp board 31 is convenient.

Referring to FIG. 5 and FIG. 10, the number of LED lamp beads 312 is plurality, and a plurality of LED lamp beads 312 are arranged around the liquid outlet hole 101 in an annular array. By using a plurality of LED lamp beads 312, it is beneficial to improve the light intensity and uniformity of the light at the liquid discharge end, so as to improve the phototherapy effect.

Referring to FIG. 5 and FIG. 10, a plurality of LED lamp beads 312 comprise at least one of blue LED lamp beads, red LED lamp beads, infrared LED lamp beads, white LED lamp beads and yellow LED lamp beads. Different phototherapy effects can be achieved when the plurality of LED lamps are multi-colored lamp beads. The plurality of LED lamp beads 312 can include infrared LED lamp beads, and infrared LED lamp beads can heat the rolling piece 20 and the liquid medicine, so that the temperature of the rolling piece 20 can be controlled, and thermal therapy is carried out. When the viscosity of the liquid medicine is large or the coagulation temperature is lower, it is conducive to improving the fluidity of the liquid medicine, so as to facilitate the uniform coating of the liquid medicine.

Referring to FIG. 3 to FIG. 5, the limiting part 13 is detachably connected with the shell 11, and the limiting part 13 and the shell 11 can be connected in a threaded connection, magnetic attraction or clamping mode, so that the disassembly of the support disc 12 is convenient, and the support disc 12 and the rolling piece 20 can be easily cleaned and maintained.

Optionally, a first hole segment is formed in the bracket 11c, a second hole segment communicated with the first hole section is formed in the plugging section 11a, and the first perforation 1101 comprises a first hole segment and a second hole section. Optionally, the first hole section is coaxially connected with the second hole section, and the connecting part can be fixed by glue or welding, so that the first perforation 1101 is straighter, and the pressure is stable when the liquid medicine is output. The splash is conducive to preventing splashing when the liquid medicine is output, and the water can be prevented from entering the battery 33 and the circuit board 32.

Referring to FIG. 3, FIG. 4 and FIG. 7, the support disc 12 is a light transmitting member, and forms a outlet area 120. The light emitted by the phototherapy light source can be conveniently transmitted through the support disc 12. The periphery of the support disc 12 can be provided with a shading coating to avoid the scattering of light, and the light intensity on the side of the support disc 12 is improved.

Referring to FIG. 7, the support disc 12 is provided with a outlet area 120 at the bottom of the accommodating groove 1201. The light emitted by the phototherapy light source can be convenient to be emitted from the front end of the support disc 12, and the ray emitted by the peripheral surface of the support disc 12 is reduced.

Referring to FIG. 2 to FIG. 4, the rolling piece 20 can be transparent or translucent, such as glass beads, crystal beads, etc. The light emitted by the phototherapy light source can be emitted from the rolling piece 20, and is conducive to improving the light intensity of the phototherapy light source. Moreover, as the rolling piece 20 rolls around the limiting part 13, the intensity of the light emitted by the phototherapy light source can change periodically, which is conducive to improving the phototherapy effect.

Referring to FIG. 2 and FIG. 8, the face of the limiting part 13 around the second perforation 1301 is made of metal that acts as a second stimulation element. Additionally, the circumference of the circulating groove 102 is provided with a metal plate to serve as the second stimulation element. The second stimulation element includes but is not limited to a heating element, a coiling element, a micro-current electrode.

Referring to FIG. 2 to FIG. 4, the rolling piece 20 is a ball that can be rolled and provides massage to the skin. In the rolling process of the ball, the liquid medicine is evenly applied to the skin, and the heat is dispersed evenly through the rolling piece 20 that is conducive to the heat dissipation of the lamp board 31.

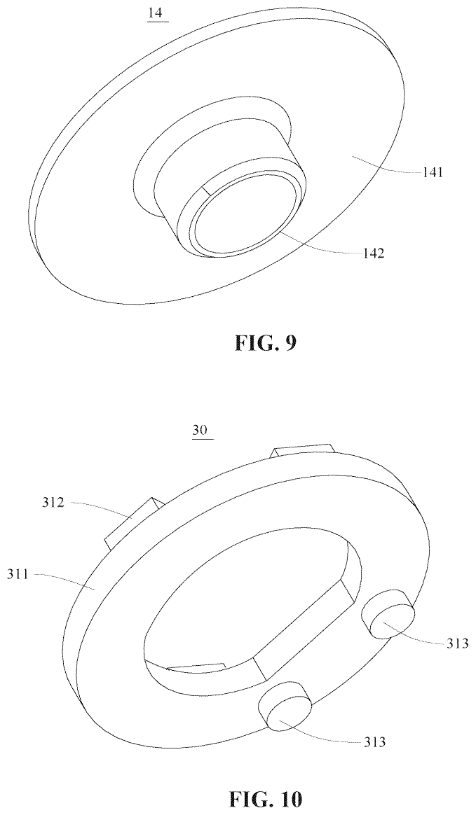

Referring to FIG. 4, FIG. 5 and FIG. 9, the massage head 100 further comprises a seal 14. The seal 14 comprises a translucent disc 141 and a sealing ring 142. The translucent disc 141 is annular shaped and the sealing ring 142 is connected with the inner edge of the translucent disc 141. The translucent disc 141 is located between the support disc 12 and the lamp board 31. The outer diameter of the translucent disc 141 is greater than the outer diameter of the lamp board 31, and the outer edge of the translucent disc 141 seals the support disc 12 and the inner wall of the shell 11. The scaling ring 142 is sleeved on the limiting part 13, and the scaling ring 142 extends from the translucent disc 141 to one side of the lamp board 31 that is far away from the translucent disc 141. The scaling ring 142 is distant from the translucent disc 141 and seals the gap between the limiting part 13 and the inner wall of the shell 11. The lamp board 31 can be isolated from the support disc 12 through the seal 14, so that the sealing of the lamp board 31 is guaranteed, and the liquid medicine or moisture are prevented from contacting the lamp board 31. The seal 14 can be a transparent part, such as a transparent silicone layer to allow transmission of light.

Referring to FIG. 3, FIG. 4 and FIG. 6, the liquid outlet end of the shell 11 is provided with a first step portion 111, a second step portion 112, a third step portion 113 and a fourth step portion 114. The first step portion 111 is used for locating the support disc 12, the second step portion 112 is used for locating the outer edge of the translucent disc 141, the third step portion 113 is used for accommodating the lamp board 31, and the fourth step portion 114 is used for locating one end of the sealing ring 142 that is far away from the translucent disc 141. The radius of the first step portion 111, the second step portion 112, the third step portion 113 and the fourth step portion 114 decrease sequentially. The first step portion 111 is used for locating the position of the support disc 12 and the installation position of the support disc 12 is conveniently controlled. The second step portion 112 is used for locating the outer edge of the translucent disc 141, so that the outer edge of the translucent disc 141 can seal the gap between the support disc 12 and the inner wall of the shell 11. The third step portion 113 is used for accommodating the positioning lamp board 31, so that the installation position of the lamp board 31 can be easily controlled. The fourth step portion 114 ensures that one end of the sealing ring 142 can be positioned away from the translucent disc 141, so as to facilitate the restriction of the movement of the seal 14 and seal the gap between the limiting part 13 and the inner wall of the shell 11.

In an optional embodiment, the outer edge of the translucent disc 141 and the second step portion 112 may be fixed by pasting or welding. The sealing ring 142 and the fourth step portion 114 may be fixed by pasting or welding.

In an optional embodiment, the shell 11 is provided with a positioning protrusion 116, and the positioning protrusion 116 is used for cooperating with the positioning lamp board 31 to restrain the lamp board 31 from rotating around the limiting part 13. This facilitates the alignment of the lamp board 31, maintain the stability of the position of the lamp board 31, and is convenient for the lamp board 31 to be connected with the circuit board 32.

Referring to FIG. 3, FIG. 4 and FIG. 7, the support disc 12 is provided with a fifth step portion 121. The fifth step portion 121 is used for matching the position of positioning the shell 11. This improves the sealing performance between the support disc 12 and the shell 11 to ensure the stability of the position of the support disc 12.

In an embodiment, when the rolling piece 20 rolls along the circulating groove 102, the light intensity can also change periodically, thereby improving the phototherapy effect, and the heat is also easier to conduct out. The height of each rolling piece 20 is greater than the depth of the circulating groove 102, so that when the liquid outlet end of the housing 10 is massaged, the part of the rolling piece 20 that is higher than the circulating groove 102 is in contact with the skin.

Referring to FIG. 2 to FIG. 4, the rolling piece 20 is a ball, and the width of the opening of the circulating groove 102 is less than the diameter of the ball. The ratio of the depth of the circulating groove 102 to the height of the rolling piece 20 is in the range of 0.55 to 0.95. In this way, the ball can be limited in the circulating groove 102, and a part of the ball part is exposed from the circulating groove 102, so that it can be in contact with the skin and achieve the massage effect. Optionally, the ratio of the width of the opening of the circulating groove 102 to the diameter of the ball is 0.2 to 0.9, so that the ball can be prevented from falling out of the circulating groove 102. In some embodiments, the rolling piece 20 may also be of a columnar roller structure, so as to realize rotation around its axis while moving in circulation along the circulating groove 102.

In an optional embodiment, the ratio of the depth of the circulating groove 102 to the height of the rolling piece 20 is 0.65, 0.75 or 0.85, so that the exposed height of the rolling piece 20 can be controlled, and the rolling piece 20 can be prevented from falling out of the circulating groove 102.

In an optional embodiment, the ratio of the width of the opening of the circulating groove 102 to the diameter of the ball is 0.4, 0.6 or 0.8, so that the exposed area of the rolling piece 20 can be controlled, and the rolling piece 20 can be prevented from falling out of the circulating groove 102.

Referring to FIG. 2 to FIG. 4, number of plurality of rolling pieces 20 is in range of 5 to 50. With the increase in number of the rolling pieces, contact surface between the rolling piece 20 and the skin can be enlarged, and the massage efficiency and the application efficiency of the liquid medicine can be improved. Optionally, the number of rolling pieces 20 can be 8, 12, 20 or 30, so that the number of rolling pieces 20 can be adjusted according to the size of the liquid outlet hole 101 and the size of the rolling pieces 20, so that the whole circulating groove 102 can be filled conveniently.

Referring to FIG. 2 to FIG. 4, and the number of circulating grooves 102 is in range of 1 to 6. When the number of circulating grooves 102 is plurality, the diameter of the plurality of circulating grooves 102 can be increased sequentially, and the plurality of circulating grooves 102 can be concentrically arranged. In this way, the number of circulating grooves 102 can be adjusted according to the size of end face of the second end 104, so as to increase the number of rolling pieces 20 and increase the massage area.

Referring to FIG. 2 to FIG. 4, the end face of the second end 104 is inclined at an angle, and the angle between the end face of the second end 104 and the length direction of the housing 10 is in range of 15 degree to 75 degree. The inclined end face allows a user to conveniently hold the massage head while massaging. Optionally, the angle between the end face of the second end 104 and the length direction of the housing 10 (as shown in the vertical direction in FIG. 3) can be 30°, 45° or 60°, so that the needs of different parts or holding postures can be satisfied.

Referring to FIG. 2, FIG. 3 and FIG. 5, a plate 30 having one or more stimulation element, a circuit board 32 and a battery 33 are installed in the housing 10. The plate 30 having one or more stimulation element is used for carrying out alternate therapy, such as physiotherapy or a phototherapy. The plate 30 having one or more stimulation element is electrically connected with the circuit board 32 and the circuit board 32 is used for driving the one or more stimulation element on plate 30. The battery 33 is electrically connected with the circuit board 32. The plate 30 having one or more stimulation element is used to provide second therapy to the skin when the massage head 100 is massaging, which contributes to the improvement of the user experience.

Referring to FIG. 2, FIG. 3 and FIG. 5, the plate 30 having one or more stimulation element comprises at least one of the phototherapy light sources for skin phototherapy, a vibrator for vibrating massage and a microcurrent electrode for microcurrent massage. By using a phototherapy light source, it is possible to perform light therapy beauty at the same time as massage. By adopting a vibrator, it is possible to perform a vibrating massage during the rolling piece 20 rolling, and the massage experience is enhanced. By using microcurrent electrodes, microcurrent physiotherapy can be performed to improve the user experience.

In an optional embodiment, a seal 14 is installed on the shell 11, and the seal 14 is used for separating the phototherapy light source from the support disc 12 to isolate the phototherapy light source and the medicinal solution. Optionally, a second opening 3101 is formed in the phototherapy light source, and the limiting part 13 is penetrated in the second opening 3101, so that the installation of the limiting part 13 and the phototherapy light source is convenient.

Referring to FIG. 2, FIG. 3 and FIG. 5, the housing 10 is provided with a first electrode 34 and a second electrode 35. A one end of the first electrode 34 and the second electrode 35 is electrically connected with the circuit board 32, and the other end of the first electrode 34 and the second electrode 35 is exposed to the housing 10. The first electrode 34 and the second electrode 35 can be connected with an external circuit to facilitate the charging of the battery 33.

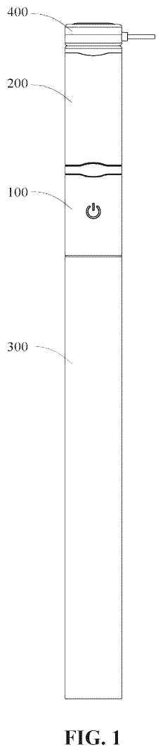

Referring to FIG. 1 to FIG. 3, the embodiment of the present application also provides a liquid storage bottle, comprising a bottle body 300, and the liquid storage bottle further comprises a multi-functional bottle head in any of the above embodiments. The input end is connected with the first end 103 of the housing 10. When the liquid medicine in the bottle body 300 is output, it can flow into the liquid outlet hole 101, so that the liquid can be dispensed through the massage head 100. The liquid storage bottle can have the effect of rolling massage and phototherapy, and the function of the liquid storage bottle is increased.

The shell 11 and the bottle body 300 can be threaded or snapped, and can also be connected by welding and other means, so as to ensure that the shell 11 and the bottle body 300 are connected stably.

Referring to FIG. 1 to FIG. 3, the liquid storage bottle further comprises a cover body 200, and the cover body 200 is capped at the outlet end of the massage head 100. When the liquid is not suitable for medicine, the cover body 200 can be covered at the outlet end of the massage head 100, so as to prevent the massage head 100 and the liquid medicine from being contaminated.

Referring to FIG. 1 to FIG. 3, the plugging section 11a is provided with a convex 115, and the cover body 200 is provided with a clamping position (not shown) for clamping with the convex 115. By adopting the convex 115 to cooperate with the clamping position, it is conducive to maintaining the stability of the connection between the cover body 200 and the massage head 100.

Referring to FIG. 1 to FIG. 3, the cover body 200 is provided with a first terminal that is electrically connected with the first electrode 34, a first conductive piece for connecting the first terminal and an external circuit, a second terminal that is electrically connected with the second electrode 35 and a second conductive piece for connecting the second terminal and an external circuit. The external circuit can be electrically connected with the massage head 100 through the cover body 200 in order to facilitate the charging of the battery 33. Optionally, the first electrode 34 may be a conductive pin embedded in the plugging section 11a or a conductive ring sleeved on the plugging section 11a, so that it can be conveniently electrically connected with the cover body 200.

Referring to FIG. 1 to FIG. 3, the reservoir bottle further comprises a charging base 400, and the two ports of the charging base 400 are in contact with the first conductive part and the second conductive part respectively to charge the massage head 100.

Referring to FIG. 1 to FIG. 3, a first magnetic suction is installed on the cover body 200, a second magnetic suction is installed on the charging base 400, and the second magnetic suction is matched with the first magnetic suction. In this way, it is conducive to ensuring that the charging base 400 and the cover body 200 are connected stably during charging.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A multi-functional bottle head, comprising:
a housing having a first end for connecting a bottle body and a second end having a circulating groove arranged in an annular manner;
a plurality of rolling pieces placed in the circulating groove, wherein height of each of the plurality of rolling piece is more than depth of the circulating groove;
a liquid outlet hole that runs through the first end and the second end in housing for communicating with the bottle body; and
wherein the circulating groove is arranged around the liquid outlet hole.

2. The multi-functional bottle head of claim 1, wherein the housing comprises a shell having an accommodating groove and a limiting part positioned at center of the accommodating groove, wherein the shell and the limiting part form the circulating groove.

3. The multi-functional bottle head of claim 2, wherein the shell comprises a first perforation, and the limiting part comprises a second perforation communicated with the first perforation, wherein the first perforation and the second perforation forms the liquid outlet hole.

4. The multi-functional bottle head of claim 3, wherein the limiting part comprises a limiting ring to place the limiting part in the accommodating groove, wherein diameter of the limiting ring increases from bottom of the accommodating groove to an opening of the accommodating groove.

5. The multi-functional bottle head of claim 1, wherein the plurality of rolling pieces are a ball, wherein width of an opening of the circulating groove is less than diameter of the ball.

6. The multi-functional bottle head of claim 1, wherein the second end of the housing is inclined at an angle, the angle is in range of 15 degree to 75 degree.

7. The multi-functional bottle head of claim 1, wherein the housing further comprises an a plate having one or more stimulation element to provide therapy to a user.

8. The multi-functional bottle head of claim 7, wherein the one or more stimulation element comprises a phototherapy lamp plate for phototherapy, a vibrator for vibrating massage or a micro-current electrode.

9. A multi-functional bottle head comprising:
a housing having a liquid outlet hole, the liquid outlet hole has an outlet area arranged around the liquid outlet hole;
a plate containing one or more stimulation element is provided below the outlet area; and
a plurality of rolling piece is installed in the outlet area, above the plate containing one or more stimulation element.

10. The multi-functional bottle head of claim 9, wherein the housing comprises a shell, a support disc installed at the liquid outlet end and a limiting part for limiting the support disc to be located on the shell.

11. The multi-functional bottle head of claim 10, wherein the one or more stimulation element is a phototherapy light source comprising a lamp board arranged around the liquid outlet hole, a circuit board electrically connected with the lamp board and a battery electrically connected with the circuit board.

12. The multi-functional bottle head of claim 11, wherein the support disc comprises an accommodating groove and a first opening is provided in the accommodating groove; and the lamp board comprises a second opening, wherein the limiting part passes through the first opening and the second opening.

13. The multi-functional bottle head of claim 11, wherein the shell comprises a first perforation and the limiting part comprises a second perforation, the first perforation and the second perforation are connected to from the liquid outlet hole.

14. The multi-functional bottle head of claim 11, wherein the supporting disc is transparent to allow light to pass through.

15. The multi-functional bottle head of claim 9, wherein the plurality of rolling piece are transparent.

16. The multi-functional bottle head of claim 14 further comprising a seal, the seal comprises an annular translucent disc and a sealing ring connected with an inner edge of the translucent disc.

17. The multi-functional bottle head of claim 9, wherein the housing comprises a circulating groove arranged around the liquid outlet hole and the plurality of rolling piece are arranged in annular array in the circulating groove.

18. A multi-functional bottle head comprising:
a housing having a first end for connecting a bottle body and a second end having a circulating groove arranged in an annular manner;
a plurality of rolling pieces placed in the circulating groove;
a liquid outlet hole that runs through the first end and the second end in housing for communicating with the bottle body;
wherein the second end of the housing comprises a second stimulation element.

19. The multi-functional bottle head of claim 18, wherein the second stimulation element is a metal plate around the liquid outlet hole.

20. The multi-functional bottle head of claim 18, wherein circumference of the circulating groove is a metal part that acts as the second stimulation element.
